(19) United States
(12) Patent Application Publication
(10) Pub. No.: US 2007/0206219 A1
(43) Pub. Date: Sep. 6, 2007

(54) Information processing apparatus, computer program product, and computer-readable storage medium

(76) Inventor: Hideki Yanagi, Ibaraki (JP)

Correspondence Address: DICKSTEIN SHAPIRO LLP, 1825 EYE STREET NW, Washington, DC, 20006-5403, US

(21) Appl. No.: 11/713,013

(22) Filed: Mar. 2, 2007

(30) Foreign Application Priority Data
Mar. 3, 2006 (JP) 2006-058061
Jan. 31, 2007 (JP) 2007-020968

(51) Int. Cl. G06F 3/12

(52) U.S. Cl. 358/1.15

(57) ABSTRACT

A printer-information control section outputs printer information of printers found by a search to a UI control section. The UI control section displays a list of the printers on a display unit. A user can add information as desired in this list. When the user select a printer from this list, information about the selected printer is added to the printer information acquired from the printers. The updated printer-information is stored.

### CROSS-REFERENCE TO RELATED APPLICATIONS

The present document incorporates by reference the entire contests of Japanese priority document, 2006-058061 filed in Japan on Mar. 3, 2006 and 2007-020968 filed in Japan on Jan. 31, 2007.

### BACKGROUND OF THE INVENTION

1. Field of the Invention

The present invention relates to a technology for performing print processing using information on a printing apparatus connected to a network.

2. Description of the Related Art

With the spread of the mobile technologies in recent years, as a general practice, it has become possible for the users to use various information terminals, such as notebook computers, personal digital assistants (PDA), and print data using printers set where the users are visiting.

Conventional technologies related to such a mobile environment are proposed in, for example, Japanese Patent Application Laid-Open Nos. 2003-99214, 2003-99231, and 2002-351790.

However, in the conventional technologies, a user has to search for a printer on a network every time the user prints data or input a printer name or the like before printing. Therefore, even when there is a familiar printer in a place where the user is visiting, the user has to wait for a result of the network search. As processing by a computer, the computer has to perform needless communication.

### SUMMARY OF THE INVENTION

It is an object of the present invention to at least partially solve the problems in the conventional technology.

According to an aspect of the present invention, an information processing apparatus that performs print processing by using information on at least one printing apparatus from among printing apparatuses connected to a network, includes a storing unit that stores therein printing apparatus information that is information about the printing apparatuses connected to a network; an acquiring unit that acquires the printing apparatus information from the storing unit in response to a print instruction for predetermined data; and a display control unit that performs control to display the printing apparatus information acquired by the acquiring unit together with present states of each of the printing apparatuses connected to the network whereby it is possible to designate a printing apparatus among the printing apparatuses as print destinations of the predetermined data.

According to another aspect of the present invention, a computer program product that includes program codes that causes a computer to perform print processing by using information on at least one printing apparatus from among printing apparatuses connected to a network, causes the computer to execute acquiring printing apparatus information from a storing unit, which stores therein printing apparatus information that is information about the printing apparatuses connected to a network, in response to a print instruction for predetermined data; and performing control to display the printing apparatus information acquired at the acquiring together with present states of each of the printing apparatuses connected to the network whereby it is possible to designate a printing apparatus among the printing apparatuses as print destinations of the predetermined data.

According to still another aspect of the present invention, a computer-readable storage medium stores therein the computer program product.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a printing system diagram in which an information processing apparatus according an embodiment to the present invention is applied to a portable terminal apparatus;

FIG. 2 is an exemplary hardware diagram of the portable terminal apparatus;

FIG. 3 is an exemplary software diagram of the portable terminal apparatus;

FIG. 4 is a flowchart of a process procedure performed by the portable terminal apparatus;

FIG. 5 is a flowchart of another process procedure performed by the portable terminal apparatus;

FIG. 6 is an example of a screen displayed on the portable terminal apparatus;

FIG. 7 is a flowchart of another process procedure performed by the portable terminal apparatus;

FIG. 8 is an example of a screen displayed on the portable terminal apparatus; and

FIG. 9 is an example of another screen displayed on the portable terminal apparatus.

### DETAILED DESCRIPTION OF THE PREFERRED EMBODIMENTS

Exemplary embodiments of the present invention are explained in detail below with reference to the accompanying drawings.

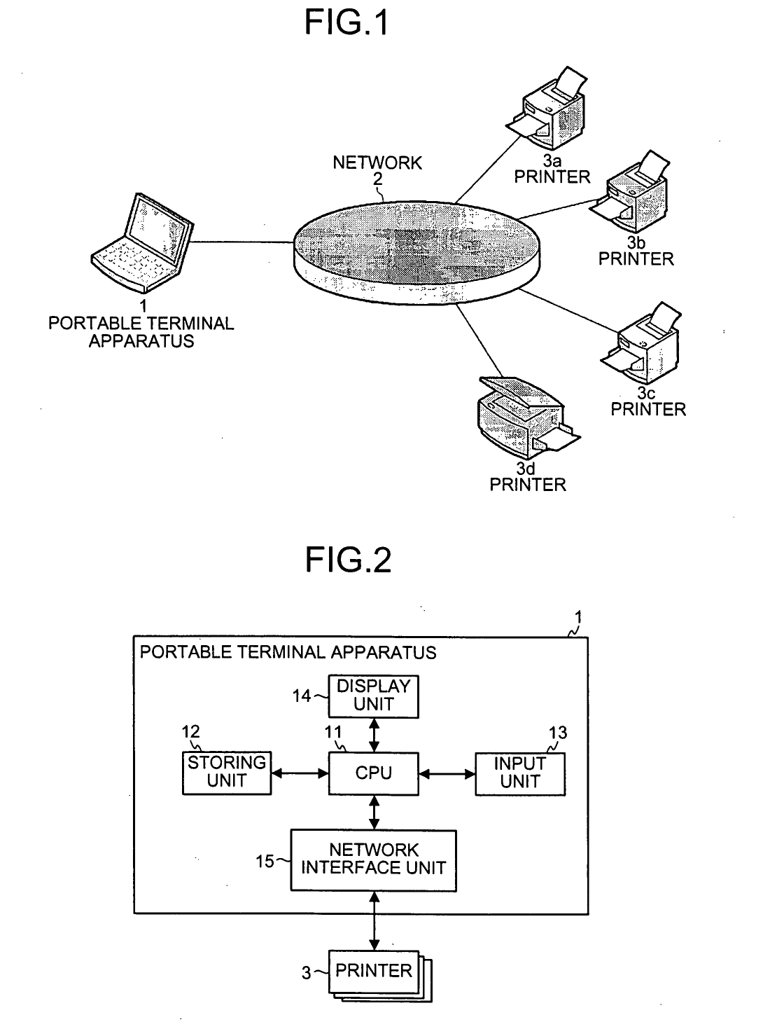

FIG. 1 is a diagram of a printing system in which an information processing apparatus according to the present invention is applied to a portable terminal apparatus according to an embodiment of the present invention. In the printing system, a portable terminal apparatus 1 such as a notebook computer or a personal digital assistant (PDA) and printers 3 (3a, 3b, 3c, . . . ) as an example of printing apparatuses such as a laser printer, a digital multifunction product, and an ink-jet printer are connected via a network 2.

Unless specifically noted otherwise, a type of the network 2 may be a wire network or a wireless network and the portable terminal apparatus 1 is not limited to the notebook computer, the PDA, and the like.

FIG. 2 is an exemplary hardware configuration of the portable terminal apparatus 1. The portable terminal apparatus 1 includes a central processing unit (CPU) 11 that controls processing of the entire apparatus, a storing unit 12 having various programs and the like stored therein, an input unit 13 such as a keyboard and a mouse, a display unit 14 such as a CRT display or a liquid crystal display on which information processed by respective functions described later is displayed, and a network interface unit 15 that manages communication with the printers 3.

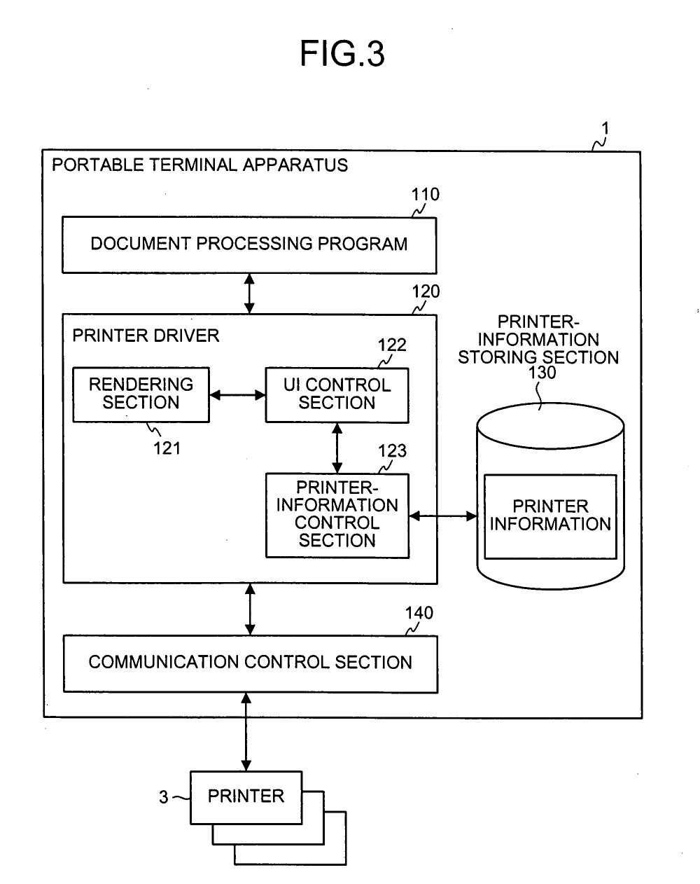

FIG. 3 is an exemplary software diagram of the portable terminal apparatus 1. The portable terminal apparatus 1 includes a document processing program 110 that runs on a not-shown operating system (OS), a printer driver 120 that generates print data interpretable by the printers 3, a printer-information storing section 130, and a communication control section 140 that performs communication with the printers 3.

The document processing program 110 is any one of various business applications such as word processor software, spreadsheet software, and document management software. The document processing program 110 may be any type of application as long as a user of the portable terminal apparatus 1 can give a print instruction to the printers 3.

The printer-information storing section 130 stores printer information acquired from the printers 3 via the communication control section 140. The printer-information storing section 130 is formed by using storage areas of storage devices such as a memory and a hard disk (HD) built in the portable terminal apparatus 1. However, the storage devices are not limited to those built in the portable terminal apparatus 1 and may be various removable media such as a universal serial bus (USB) memory and a secure digital(SD) card connected to the portable terminal apparatus 1 via an interface between the portable terminal apparatus 1 and an external medium. A format of printer information acquired from the printers 3 may be any format as long as the portable terminal apparatus 1 can treat the printer information. However, as in an example described later, it is preferable that it is possible to add information to the printer information.

The printer driver 120 includes a printer-information control section 123, a user interface (UI) control section 122, and a rendering section 121. For example, the printer-information control section 123 has a function of storing printer information in the printer-information storing section 130, detecting printer information from the printer-information storing section 130 according to a print instruction from the user, and causing the communication control section 140 to acquire present states of the printers 3a, 3b, and the like described in the printer information detected. The printer-information control section 123 also has a function of outputting details of the printer information detected and information on the present states of the printers to the UI control section 122. The UI control section 122 controls the display unit 14 to display a print setting screen and details of the printer information as a graphical user interface (GUI) for the user of the portable terminal apparatus 1. The rendering section 121 has a function of generating print data of a format interpretable by the printers 3 from the details displayed by the UI control section 122 based on a print instruction given by the user.

The communication control section 140 has a function of transmitting print data, which is transmitted from the printer driver 120, to a designated printer and a function of acquiring present states of the printers 3 according to a command from the printer-information control section 123.

The printers 3 transmit printer information and present states in response to a request from the communication control section 140 of the portable terminal apparatus 1. Various kinds of information such as the printer information and the present states are managed by a not-shown management information base (MIB) or the like. As the printer information, information capable of specifying the printers 3 such as IP addresses of the printers, various options including a finishing function such as staple and punch processing, and other executable various printing conditions are held. A type of a protocol in communication between the printers 3 and the portable terminal apparatus 1 may be any type as long as the portable terminal apparatus 1 can send a request for printer information, present states, and the like to the printers 3.

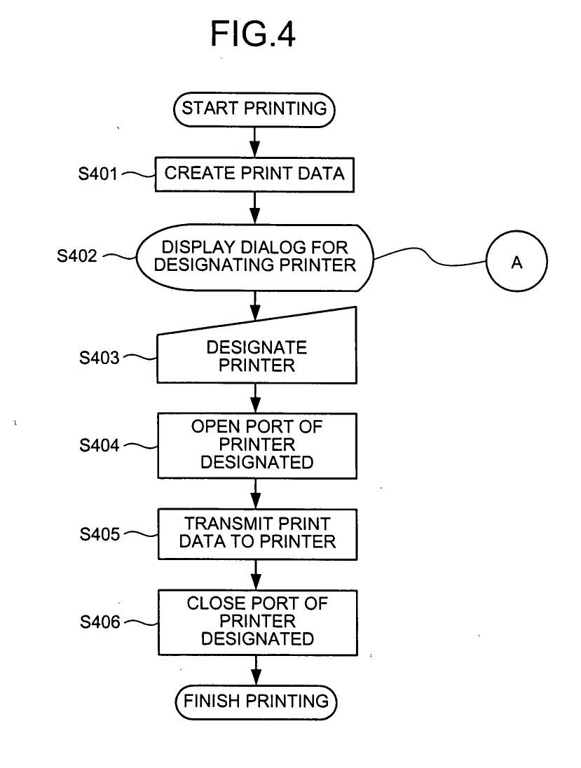

Operations of the printing system are explained below. FIG. 4 is a flowchart of a print processing performed by the portable terminal apparatus 1. First, the user of the portable terminal apparatus 1 creates predetermined data using the document processing program 110 (step S401). In printing the data, the user issues a print instruction from the document processing program 110. The document processing program 110 invokes the printer driver 120 based on the print instruction. The printer driver 120 invoked performs processing for causing the printer-information control section 123, the UI control section 122, and the like to display a dialog for designating a printer (step S402).

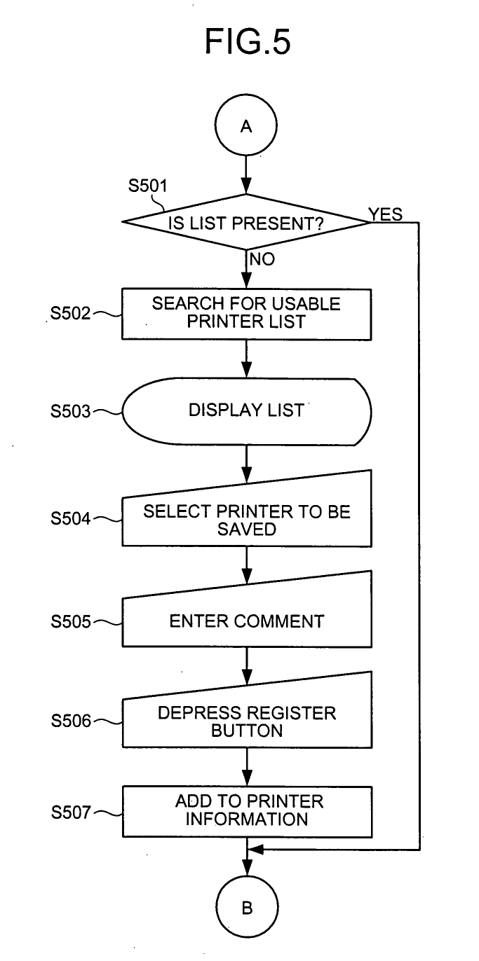

FIG. 5 is a flowchart of the processing performed to display the dialog. The printer-information control section 123 judges whether printer information acquired from the printers 3 is present with reference to the printer-information storing section 130. As a result, when the printer information is present in the printer-information storing section 130 (“Yes” at step S501), to inquire printers specified by the printer information in the printer-information storing section 130 about present states, the printer-information control section 123 shifts to step S701.

On the other hand, when the printer information is not present in printer-information storing section 130 (“No” at step S501), it is impossible to transmit the data created by the document processing program 110 to the printers in that state. Thus, the printer-information control section 123 instructs the communication control section 140 to search for a printer on the network 2 (step S502). The communication control section 140 searches for printers on the network 2 based on this instruction and returns a result of the search to the printer-information control section 123. As a method of the printer search, the communication control section 140 only has to perform the printer search using broadcast, Ping, and the like. The printer-information control section 123 outputs printer information of the printers found in the search to the UI control section 122. The UI control section 122 displays a list shown in FIG. 4 (step S503).

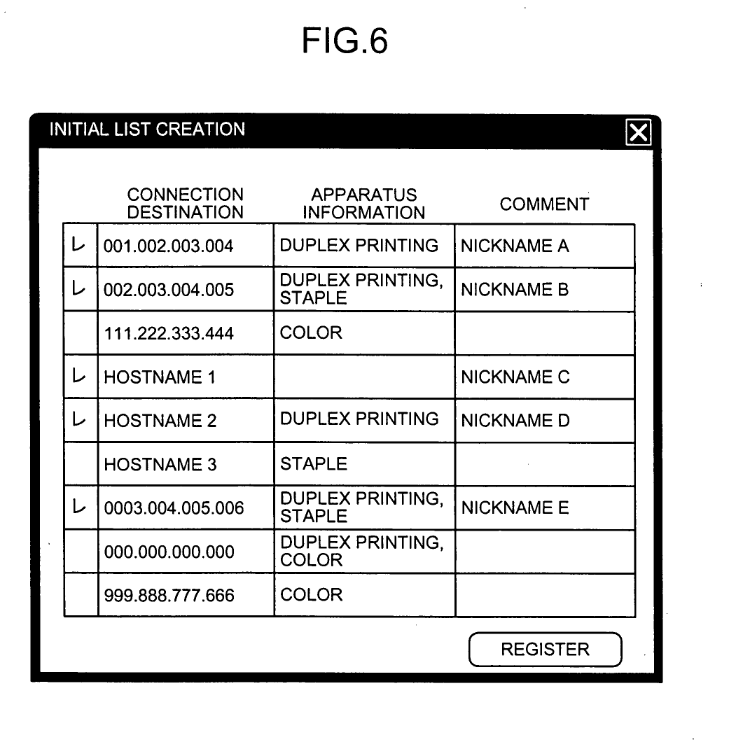

In FIG. 6, as an example of the printer information, a “connection destination” space that indicates information on addresses on the network of the printers 3, an “apparatus information” space concerning functions and options executable by the printers, and a “comment” space are displayed as a list. For example, it is seen that a printer with 001.002.003.004 in the “connection destination” space is capable of performing duplex printing and a printer with 003.004.005.006 is capable of performing duplex printing and staple processing.

In FIG. 6, printers checked on the left of the “connection destination” column are printers selected in advance as a plurality of options that the user can select when the user prints predetermined data. In other words, the UI control section 122 accepts prior selection of desired printers by the user (step S504). In this example, printers with the “connection destination” 001.002.003.004 and the “connection destination” 002.003.004.005 are printers selected in advance.

Information in the “comment” space is information on items that are not included in the printer information managed by the printers 3 and can be arbitrarily added to acquired printer information by the user. For example, when the printer with 001.002.003.004 is located near an entrance of an office where the user is present, the user can give a nickname or the like to the printer if the user wishes to give an arbitrary name that allows the user to personally recognize the printer. Thus, a user unfamiliar to printer terms can recognize a printer indicated by a connection destination. The user only has to perform setting in the “comment” space by, for example, performing setting in FIG. 6 described later or directly entering a text in this space (step S505).

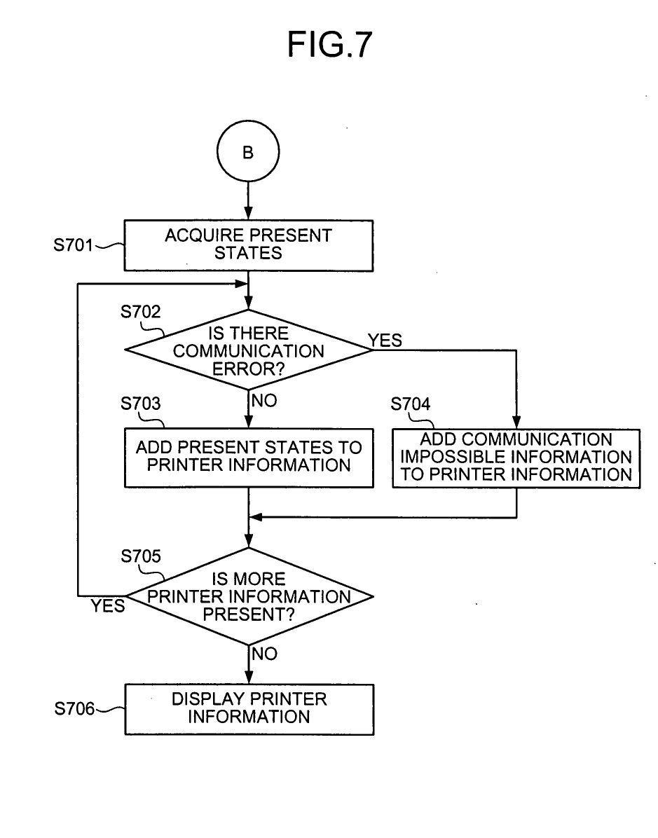

When the user depresses a “register” button through the procedure described above (step S506), information indicating that the user has selected the printer is added to the printer information acquired from the printers 3 (step S507). If a comment is entered in the “comment” space, details of the comment are also added to the printer information. The UI control section 122 notifies the printer-information control section 123 that such processing is performed. The printer-information control section 123 stores the printer information in the printer-information storing section 130 and proceeds to step S701 in FIG. 7. The storage of the printer information in the printer-information storing section 130 does not have to be performed at this point and only has to be performed until printing is finished.

Items that can be displayed as printer information in the list shown in FIG. 6 are not limited to those described above. For example, model names, manufacturer names, and the like of printers may be displayed as printer information. All the examples of the “comment” described above are nicknames. However, the “comment” is not limited to nicknames as long as the user can recognize printers. Moreover, since the “comment” is an arbitrary item, no information may be entered in the “comment” space.

FIG. 7 is a flowchart of processing from inquiry about present states of the printers 3 to acquisition of the present states. At step S701, the printer-information control section 123 inquires the communication control section 140 about present states of the printers. As a protocol for inquiring about present states of the printers, for example, a simple network management protocol (SNMP) or a Web Service is used.

The communication control section 140 communicates with the printers. When there is no communication error (“No” at step S702), i.e., when states of the printers are acquired, the communication control section 140 adds the states to the printer information (step S703). As this state, there are, for example, “standby in an energy saving mode” and “no sheet”.

On the other hand, when there is a communication error (“Yes” at step S702), i.e., present states such as “standby in an energy saving mode” and “no sheet” are not obtained, the communication control section 140 adds information such as “no response” and “error” (step S704). Depending on results of communication with the printers, the results may be distinguished, for example, a space in which a state is added is left blank or highlighted.

The communication control section 140 inquires the printers described in the printer information about present states. When there is a printer that the communication control section 140 has not inquired about a present state, the communication control section 140 continues the inquiry processing until no more printer that the communication control section 140 has not inquired about a present state is present (“Yes” at step S705). On the other hand, when a printer that the communication control section 140 has not inquired about a present state is present (“No” at step S705), the communication control section 140 notifies the printer-information control section 123 that the inquiry about present states of all the printers has been completed. The printer-information control section 123 receives the notification and instructs the UI control section 122 to display the printer information to which the states of the printers are added (step S706).

After the printer information is displayed by the UI control section 122 at step S706, the processing returns to the flowchart in FIG. 4. The printer driver 120 waits for an instruction for selecting a print destination of predetermined data by the user (step S403).

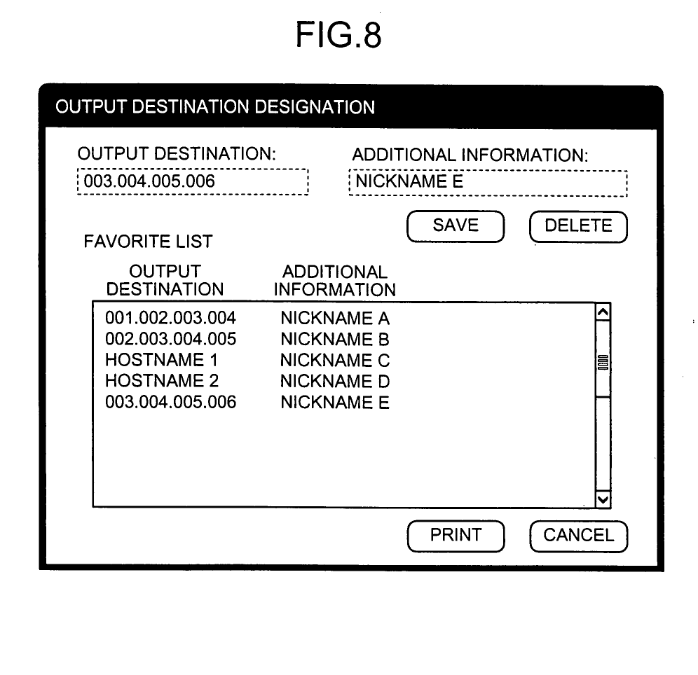

FIG. 8 is an example of a screen displayed when the printer with the “connection destination” 003.004.005.006 in FIG. 6 is selected while the printer driver 120 waits for an instruction for selection. In this example of a screen, the details of the printer information in FIG. 6 are shown in a “favorite list”. In a “print destination” space, the printer with the “connection destination” 003.004.005.006 is entered. In an “additional information” space, a “nickname E”, which is a nickname of the printer selected, is entered. A “save” button in the screen is used, for example, when the user wishes to update the printer information by entering additional information other than the “nickname E”.

A “delete” button is used in deleting desired printer information from the “favorite list”. When a printer in a connection destination address initially designated is removed because of, for example, replacement of printers in an office, it is possible to delete the printer from the “favorite list”. When the printer is deleted, the printer is also deleted from the printer information in the printer-information storing section 130.

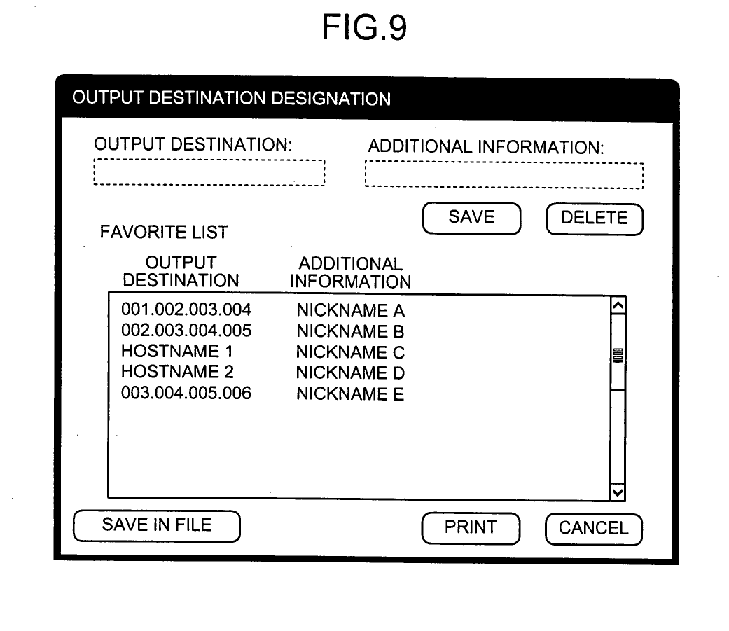

In the example described above, the printer information is stored in the printer-information storing section 130. However, when the printer-information storing section 130 is a removable medium such as a USB memory or an SD card rather than the storage device built in the portable terminal apparatus 1 or when both the built-in storage device and the removable medium are used, it is also possible to designate a file storage destination by depressing a “save in a file” button. An example of a screen in which this button is provided is shown in FIG. 9. This makes it possible to carry the printer information and use the printer information in terminals other than the portable terminal apparatus 1. Thus, it is possible to use the printer information stored in the removable medium as a logical printer.

When a “print” button in FIG. 8 is depressed, printing of predetermined data according to a print instruction is executed. In this case, the printer-information control section 123 causes the communication control section 140 to perform processing for opening a port of the print destination printer (step S404). The rendering section 121 converts the predetermined data into print data interpretable by the printer with the connection destination 003.004.005.006 and outputs the print data to the communication control section 140. The communication control section 140 transmits the print data to the printer (step S405). The communication control section 140 receives notification of completion of printing from the printer and performs processing for closing the port (step S406). As a result, a series of printing is completed.

As described above, in this embodiment, when printer information is present in the printer-information storing section 130, the user only has to designate a printer as a print destination out of printers selected by the user as printers desired as print destinations. Moreover, the user can designate the printer according to details added with present states of the printers.

When printer information is present in the printer-information storing section 130, the portable terminal apparatus 1 does not have to perform printer search on the network every time printing is instructed. This makes it possible to prevent useless communication from being performed.

Even if the printer information is not present in the printer-information storing section 130, the printer-information control section 123 acquires printer information via the communication control section 140, causes the user to select a printer as a print destination from the printer information, and stores the printer information in the printer-information storing section 130. Therefore, at the time of printing after the printer information is stored, the user can select a printer with simple operation for selecting a desired printer out of designated printers.

Moreover, when the printer information is stored in the removable medium, it is possible to distribute the printer information to a plurality of users and cause the users to use an identical printer. In storing the printer information in the removable medium, it is possible to further improve portability and security by, for example, storing the printer information in a data format of a compressed file or an encrypted file.

In this embodiment, when the printer information is not present in the printer-information storing section 130, the printer-information control section 123 inquires the communication control section 140 about present states of the printers after step S507. However, present states may be acquired at the point of step S502 by writing in a message sent to the network 2 that, for example, printers on the network 2 are searched for and printers found by the search are inquired about present states.

This embodiment is also attained by supplying a storage medium having stored therein programs of software for realizing the functions described above to a computer such as the portable terminal apparatus 1 and the computer reading out and executing the programs stored in the storage medium.

As the storage medium, it is possible to use, for example, a flexible disk, a hard disk, an optical disk, a magneto-optical disk, a compact disk-read only memory (CD-ROM), a compact disk-recordable (CD-R), a compact disk-rewritable (CD-RW), a digital versatile disk-read only memory (DVD-ROM), a digital versatile disk-random access memory (DVD-RAM), a digital versatile disk-rewritable (DVD-RW), a digital versatile disk+rewritable (DVD+RW), a magnetic tape, a nonvolatile memory card, and a read only memory (ROM).

According to an aspect of the present invention, it is possible to designate a desired printing apparatus without searching for information on printing apparatuses on the network every time printing is performed and display present states of the printing apparatuses.

The storing unit according to another aspect of the present invention includes storage devices such as a hard disk (HD) and a memory built in the computer. The printing apparatus information includes information that is capable of specifying a printing apparatus such as an IP address of the printing apparatus, options such as a finishing function, and executable printing conditions. The present state of the printing apparatus includes a state of supply of electric power, a state of consumables such as sheets and toners, and a standby state. As the predetermined storing unit, various detachably attachable storage media such as a USB memory and an SD card inserted in the computer may be used. A user may arbitrarily add comments to the printing apparatus information.

According to still another aspect of the present invention, since the printing apparatus information stored in the predetermined storing unit is used, it is possible to improve convenience of designation of a printing apparatus.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus that performs print processing by using information on at least one printing apparatus from among printing apparatuses connected to a network, the information processing apparatus comprising:
a storing unit that stores therein printing apparatus information that is information about the printing apparatuses connected to a network;
an acquiring unit that acquires the printing apparatus information from the storing unit in response to a print instruction for predetermined data; and
a display control unit that performs control to display the printing apparatus information acquired by the acquiring unit together with present states of each of the printing apparatuses connected to the network whereby it is possible to designate a printing apparatus among the printing apparatuses as print destinations of the predetermined data.

2. The information processing apparatus according to claim 1, wherein the acquiring unit acquires current states of a printing apparatus from the printing apparatus for printing apparatuses whose printing apparatus information is present in the storing unit.

3. The information processing apparatus according to claim 1, wherein the acquiring unit acquires printing apparatus information of a printing apparatus connected to the network and stores acquired printing apparatus information in the storing unit for a printing apparatus whose printing apparatus information is present in the storing unit.

4. The information processing apparatus according to claim 1, wherein the display control unit performs control to display the printing apparatus information and the present states of the printing apparatuses as a list.

5. A computer program product that includes program codes that causes a computer to perform print processing by using information on at least one printing apparatus from among printing apparatuses connected to a network, the program codes causing the computer to execute:
acquiring printing apparatus information from a storing unit, which stores therein printing apparatus information that is information about the printing apparatuses connected to a network, in response to a print instruction for predetermined data; and
performing control to display the printing apparatus information acquired at the acquiring together with present states of each of the printing apparatuses connected to the network whereby it is possible to designate a printing apparatus among the printing apparatuses as print destinations of the predetermined data.

6. The computer program product according to claim 5, wherein the acquiring includes acquiring current states of a printing apparatus from the printing apparatus for printing apparatuses whose printing apparatus information is present in the storing unit.

7. The computer program product according to claim 6, wherein the acquiring includes acquiring printing apparatus information of a printing apparatus connected to the network and stores acquired printing apparatus information in the storing unit for a printing apparatus whose printing apparatus information is present in the storing unit.

8. The computer program product according to claim 5, wherein the performing includes performing control to display the printing apparatus information and the present states of the printing apparatuses as a list.

9. A computer-readable storage medium that stores therein a computer program product that includes program codes that causes a computer to perform print processing by using information on at least one printing apparatus from among printing apparatuses connected to a network, the program codes causing the computer to execute:
acquiring printing apparatus information from a storing unit, which stores therein printing apparatus information that is information about the printing apparatuses connected to a network, in response to a print instruction for predetermined data; and
performing control to display the printing apparatus information acquired at the acquiring together with present states of each of the printing apparatuses connected to the network whereby it is possible to designate a printing apparatus among the printing apparatuses as print destinations of the predetermined data.
